(19) United States
(12) Patent Application Publication
(10) Pub. No.: US 2025/0198969 A1
(43) Pub. Date: Jun. 19, 2025

(54) MIRROR CONNECTING UNIT FOR AN INDUSTRIAL UT SYSTEM

(71) Applicant: SCANMASTER SYSTEMS (IRT) LTD., Kfar Saba (IL)

(72) Inventors: Avner DE-SWANN, Ramat Hasharon (IL); Avner BRONFELD, Givataim (IL); Ofer SELA, Kiryat Tivon (IL); Hagai ARAN, Tarum (IL)

(73) Assignee: SCANMASTER SYSTEMS (IRT) LTD., Kfar Saba (IL)

(21) Appl. No.: 18/867,702

(22) PCT Filed: May 23, 2023
(86) PCT No.: PCT/IL2023/050531

§ 371 Date: Nov. 20, 2024

(30) Foreign Application Priority Data
May 24, 2022 (IL) 293298

(51) Int. Cl. G01N 29/22; G01N 29/04

(52) U.S. Cl. CPC G01N 29/221; G01N 29/04; G01N 29/223; G01N 2291/023

(57) ABSTRACT

An industrial ultrasound (US) system is disclosed. The US system comprising: at least one US probe; at least one mirror; and at least one connecting unit comprising: a probe side adjustable unit comprising a first connector connectable to a US probe and an alignment element, wherein a location of the alignment element is adjustable with respect to the US prob; and a mirror side unit comprising a second connector connectable to a mirror and locking element located at a fixed position with respect to a reflecting surface of the mirror. In some embodiments, the alignment element is configured to be locked by the locking element, to secure a fixed relation between a direction of a US beam emitted from the probe and the reflecting surface of the mirror.

### CROSS REFERENCE TO RELATED APPLICATIONS

This application claims the benefit of priority of Israel Patent Application No. 293298, filed 24 May 2022, which is hereby incorporated by reference in its entirety.

### FIELD OF THE INVENTION

The present invention relates generally to a mirror connecting unit for an industrial Ultrasonic Testing (UT) system. More specifically, the present invention relates to an aligning mirror connecting unit for an industrial UT system.

### BACKGROUND OF THE INVENTION

An industrial Ultrasonic Testing (UT) inspection system includes an Ultrasound (US) transducer that projects and receives a US beam. When required to inspect objects that are not in the direct projection of the beam, a mirror is assembled in the direction of the beam, shifting the projected and reflected beam from and to the required object surface.

An example, of such an assembly as known in the art, is illustrated in FIG. 1. When an inspection of, for example, a vertical wall of a container or a hole is required, a 45 degrees mirror 30 is attached on a probe 20. The assembly is done, manually before the scanning. Since there are deviations in the beam direction between different US probs, an alignment of each mirror must be conducted every time a mirror is assembled on the probe. The alignment is done by rotating the mirror around the probe's main axis Z until a beam 5 hits mirror 30 surface 35, such that the beam will be reflected from surface 35 at an angle directing the beam towards the vertical wall.

When using a multi-tool automatic system with a plurality of different probes, there is no automatic way to ensure the alignment of the mirror and the probe, and a manual alignment is required each time a mirror is assembled. Therefore, such an automatic system must have two types of tools, probes for direct inspection of objects and probes connected and aligned with corresponding mirrors for inspection of vertical or tilted objects. This requires doubling the number of US probes, which are an expensive and sensitive tool.

Therefore, there is a need for a solution that will allow quick and simple alignment of the mirror and the probe during assembly, such that any mirror can immediately be connected to any probe without the need for a specific alignment.

### SUMMARY OF THE INVENTION

Some aspects of the invention are related to an industrial ultrasound (US) system, comprising: at least one US probe; at least one mirror; and at least one connecting unit comprising: a probe side adjustable unit comprising a first connector connectable to a US probe and an alignment element, wherein a location of the alignment element is adjustable with respect to the US prob; and a mirror side unit comprising a second connector connectable to a mirror and locking element located at a fixed position with respect to a reflecting surface of the mirror. In some embodiments, the alignment element is configured to be locked by the locking element, to secure a fixed relation between a direction of a US beam emitted from the probe and the reflecting surface of the mirror.

In some embodiments, the probe side unit and the mirror side unit are magnetically connected. In some embodiments, the probe side unit and the mirror side unit are mechanically connected. In some embodiments, the probe side unit and the mirror side unit are pneumatically connected.

In some embodiments, the locking element is a recess and the alignment element is a perturbance designed to be inserted into the recess, or vise versa. In some embodiments, the locking element and the alignment element are recesses, and the connecting unit further comprises a fastener configured to secure the recesses to each other. In some embodiments, wherein the locking element and the alignment element are magnets.

Another aspect of the invention may be directed to a connecting unit for an industrial UT system comprising: a probe side adjustable unit comprising a first connector connectable to at least one US probe and an alignment element, wherein a location of the alignment element is adjustable with respect to the prob; and a mirror side unit comprising a second connector connectable to a mirror and locking element located at a fixed position with respect to a reflecting surface of the mirror. In some embodiments, the alignment element is configured to be locked by the locking element, to secure a fixed relation between a direction of an US beam emitted from the probe and the reflecting surface of the mirror.

In some embodiments, the probe side unit and the mirror side unit are magnetically connected. In some embodiments, the probe side unit and the mirror side unit are mechanically connected. In some embodiments, the probe side unit and the mirror side unit are pneumatically connected.

In some embodiments, the locking element is a recess and the alignment element is a perturbance designed to be inserted into the recess, or vise versa. In some embodiments, the locking element and the alignment element are recesses, and the connecting unit further comprises a fastener configured to secure the recesses to each other. In some embodiments, the locking element and the alignment element are magnets.

Another aspect of the invention may be directed to a method for aligning an industrial UT system, comprising: providing a UT system comprising: a mirror connected to a mirror side unit comprising a second connector connectable to the mirror and a locking element located at a fixed position with respect to a reflecting surface of the mirror; and a probe connected to a probe side unit comprising a first connector connectable to the US probe and an alignment element, wherein a location of the alignment element is adjusted with respect to the probe to ensure a fixed relation between a direction of an US beam emitted from the probe and the reflecting surface of the mirror; and locking the alignment element with the locking element thereby ensure the alignment between a direction of a US beam emitted from the probe and the reflecting surface of the mirror.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is an illustration of a portion of a prior art industrial UT system;

FIG. 2A is an illustration of an industrial UT system according to some embodiments of the invention;

FIGS. 2B and 2C are illustrations of connecting units for an industrial UT system according to some embodiments of the invention;

FIGS. 3A and 3B are illustrations of another industrial UT system having a different connecting unit, according to some embodiments of the invention; and

FIG. 4 is a flowchart of a method of aligning an industrial UT system according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

Some aspects of the invention may be directed to a connecting unit for an industrial UT system that allows a quick, automatic connection of a US probe and a mirror while ensuring correct alignment between a US beam projected or emitted by the probe and the reflecting surface of the mirror. Such a connecting unit may allow a complete automated connection between any probe tool of the same type and any mirror of the same type, therefore, may allow using of the same probes with and without mirrors in a completely automated production line. In some embodiments, connecting and disconnecting the mirror to the probe may be done by a simple connecting step, that can be performed by a robot.

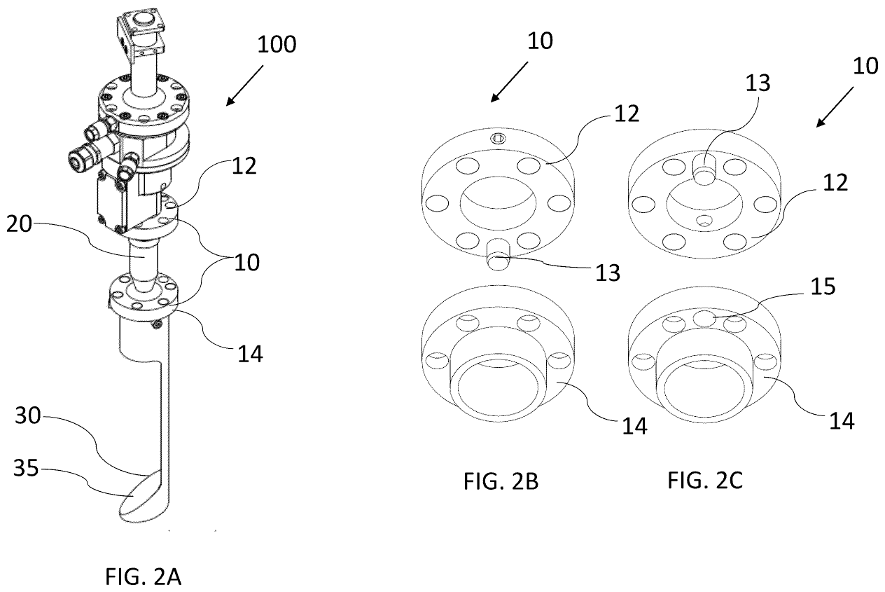

Reference is now made to FIG. 2A which is an industrial UT system 100 according to some embodiments of the invention. System 100 may include at least one US probe 20, at least one mirror 30 and at least one connecting unit 10 configured to detachably connect any US probe 20 of the same type to any mirror 30 of the same type (e.g., having similar holders having the same diameter). Probe 20 may be any industrial US probe that is configured to project US beams to an object and receive US beams reflected from the object. In some embodiments, US probe 20 may include or may be connected to a tool connector 40 for connecting the probe to automatic scanning system 100. In some embodiments, US probe 20 may include or may be connected to any additional connector as required, therefore at least one connecting unit 10 may connect directly or indirectly to probe 20.

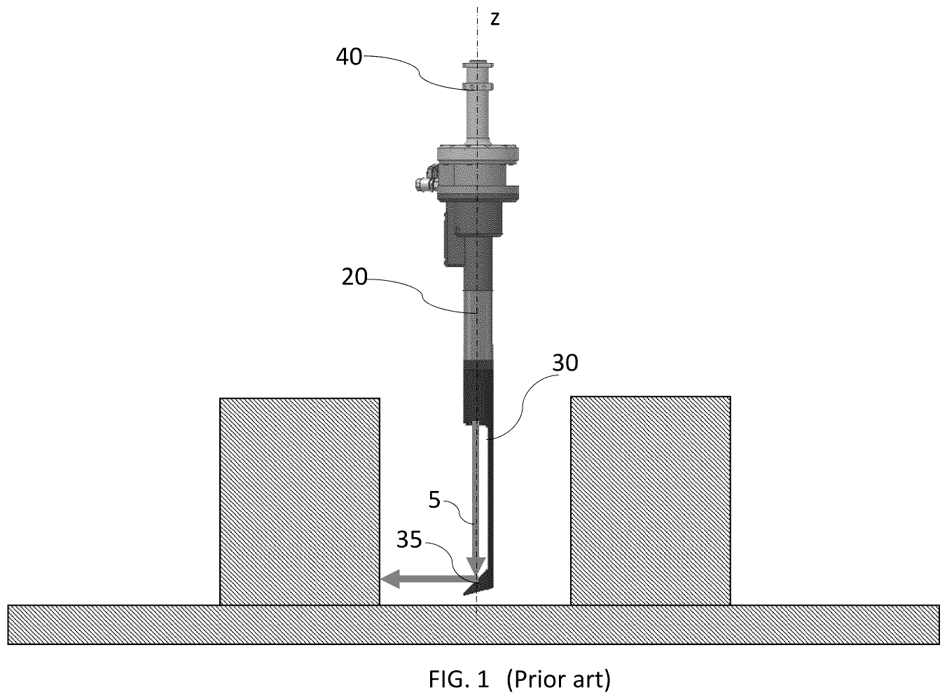

US mirror 30 may be any US mirror known in the art as having at least one reflecting surface 35 for reflecting and directing a US beam, such as beam 5 illustrated in FIG. 1. As should be understood by one skilled in the art, the 45 degrees mirror illustrated in FIGS. 1 and 2A is given as an example only, and the invention is not limited to this specific form, shape or angle.

In some embodiments, connecting unit 10 may include a probe side adjustable unit 10P and a mirror side unit 10M, which are further illustrated and discussed with respect to FIGS. 2B and 2C.

Reference is now made to FIGS. 2B and 2C which are illustrations of two positions of connecting unit 10 according to some embodiments of the invention. Probe side adjustable unit 10P of connecting unit 10 may include a first connector 12 connectable to US probe 20 and an alignment element 13. In some embodiments, a location of alignment element 13 is adjustable with respect to the prob. More specifically, first connector 12 or alignment element 13 can move around the central axis Z of probe 20, thus changing the location of alignment element 13. In the non-limiting example, illustrated in FIGS. 2B and 2C, the location of alignment element 13 (e.g., perturbance/pin) is fixed with respect to connector 12 which can rotate around axis z of probe 20. Upon reaching a required location, alignment element 13 and/or first connector 12 may be fixated using a fixating locker, such as illustrated screw 11.

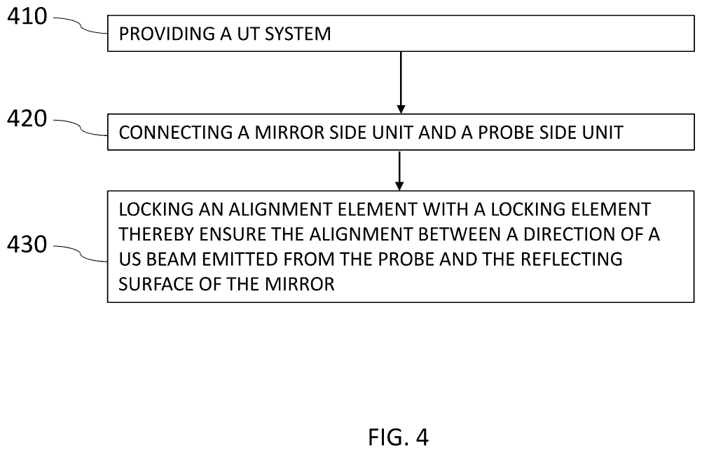

In some embodiments, the required position or location of alignment element 13 may be determined during an initial alignment process which may be conducted using any mirror 30 assembled with mirror side unit 10M. In some embodiments, the alignment process may secure a fixed relation between a direction of a US beam emitted from probe 20 and reflecting surface 35 of mirror 30, as discussed hereinbelow with respect to the method of FIG. 4.

In some embodiments, first connector 12 and alignment element 13 are included in a single element, for example, the machined element illustrated. In other embodiments, first connector 12 and alignment element 13 are two separate elements such that alignment element 13 is connectable to first connector 12. In some embodiments, first connector 12 is previously assembled on probe 20 (for example, in the OEM premises) and alignment element 13 is aligned and assembled according to embodiments of the present invention.

In some embodiments, mirror side unit 10M may include a second connector 14 connectable to mirror 30 and locking element 15 located at a fixed position with respect to reflecting surface 35 of the mirror 30. For all mirrors of the same type, the location of locking element 15 is the same. Therefore, no adjusting or alignment process is required to the mirror side. In some embodiments, alignment element 13 is configured to be locked by locking element 15, to secure a fixed relation between a direction of a US beam emitted from probe 20 and reflecting surface 35 of mirror 30.

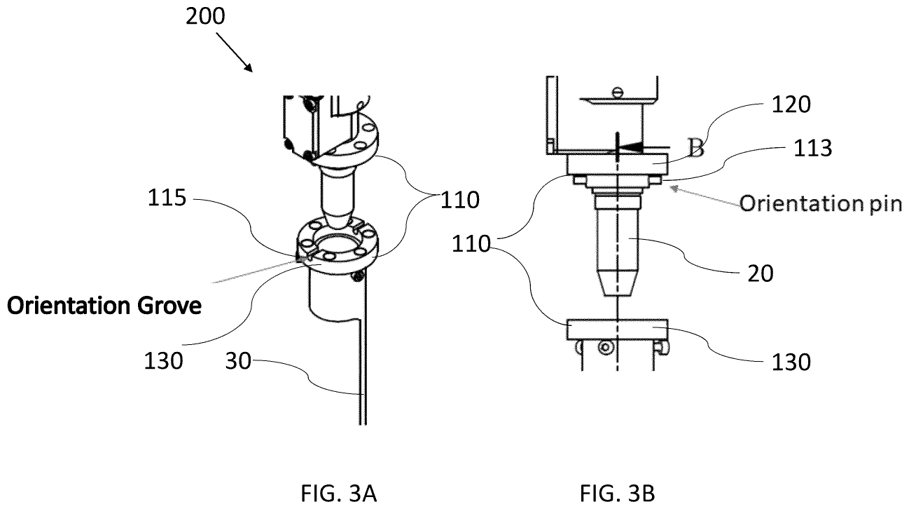

In some embodiments, locking element 15 is a recess, and aliment element 13 is a perturbance/pin designed to be inserted into the recess (as illustrated), or vise versa. In some embodiments, locking element 15 and aliment element 13 are recesses, and the connecting unit further comprises a fastener, not illustrated, configured to secure the recesses to each other. An additional non-limiting example, for locking element 115 and aliment element 113 included in a connecting unit 110 is given in with respect to FIGS. 3A and 3B.

In some embodiments, locking element 15 and alignment element 13 may be or may include magnets. In such case, the magnets can be fixatedly connected to first connector 12 and/or second connector 14, or detachably connected (e.g., via magnetic forces) to first connector 12 and/or second connector 14.

In some embodiments, probe side unit 10P and mirror side unit 10M are magnetically connected, for example, connector 12 may include one or more magnets 16, and connector 14 may be made from a ferromagnetic alloy or may include one or more magnets, like magnets 16. In another embodiment, probe side unit 10P and mirror side unit 10M are mechanically connected, using any known quick release connector(s). In another embodiment, probe side unit 10P and mirror side unit 10M are pneumatically connected, for example, by vacuum mini-chambers (not shown) in either the first or the second connectors.

Reference is now made to FIGS. 3A and 3B which are illustrations of two views of an industrial UT system 200 according to some embodiments of the invention. System 100 may include at least one US probe 20, at least one mirror 30 and at least one connecting unit 110 configured to detachably connect any US probe 20 of the same type to any mirror 30. US probes of similar types may include all the US probes that can be detachably connected to the same tool connector and the same mirror holder, the US probes do not have to be substantially identical and can differ in the US wave application properties (e.g., intensity, wavelength, etc.). Connecting unit 110 may include a probe side adjustable unit 110P and a mirror side unit 110M.

In some embodiments, probe side adjustable unit 110P may include a first connector 112 connectable to US probe 20 and an alignment element 113, for example, the orientation pin illustrated. In some embodiments, a location of alignment element 113 is adjustable with respect to probe 20. In the nonlimiting example of FIGS. 3A and 3B the orientation pin is not fixatedly connected to first connector 112, but rather added below connector 112, previously connected to probe 20.

In some embodiments, mirror side unit 110M may include a second connector 114 connectable to mirror 30 and locking element 115 located at a fixed position with respect to reflecting surface 35 of the mirror 30. For all mirrors of the same type, the location of locking element 115 is the same. In the non-limiting example of FIGS. 3A and 3B locking element 115 is an orientation grove made in second connector 114. In some embodiments, the orientation pin of alignment element 113 is configured to be locked by the grove of locking element 115, to secure a fixed relation between a direction of a US beam emitted from probe 20 and reflecting surface 35 of mirror 30.

Reference is now made to FIG. 4 which is a flowchart of a method of aligning an industrial UT system according to some embodiments of the invention.

In step 410, a UT system such as UT systems 100 or 200 may be provided. In some embodiments, each system may include a mirror 30 connected to a mirror side unit 10M or 110M; and a probe 20 connected to a probe side unit 10P or 110P. In some embodiments, the location of alignment element 13 or 113 is adjusted with respect to probe 20 to ensure a fixed relationship between a direction of a US beam emitted from probe 20 and the reflecting surface 35 of mirror 30.

In some embodiments, a pre-alignment process may be conducted to probe 20 using any mirror. Upon connecting mirror side unit 10M or 110M to probe side connecting unit, a manual alignment of the location of alignment element 13 or 113 is conducted by rotating either alignment element 13 or 113 or first connector 12 or 112, such that, a required optimal relation between a direction of a US beam emitted from probe 20 reflecting surface 35 of mirror 30 is achieved. Upon reaching the optimal location, either alignment element 13 or 113 or first connector 12 or 112 is fixated, for example, by fixating element 11.

In some embodiments, mirror side unit 10M or 110M may be disconnected from probe side unit 10P or 110P, allowing any mirror connected to mirror side unit 10M or 110M to be connected to the aligned probe. This process may be conducted to all probes 20 in a production line.

In step 420, which may be conducted automatically during production, mirror side unit 10M or 110M of provided system 100 or 200 may be connected to probe side unit 10P or 110P of provided system 100 or 200. An automatic system may bring and place probe 20 connected to probe side connector 10P or 110P on top of mirror side connector 10M or 110M, connecting the two. The automatic system may select to place any probe 20 connected to probe side connector 10P or 110P on top of any mirror side connector 10M or 110M, included in system 100 or 200.

In step 430, which may also be conducted automatically during production, alignment element 13 or 113 may be locked by locking element 15 or 115 thereby ensuring the alignment between a direction of the US beam emitted from the probe and the reflecting surface of the mirror.

Unless explicitly stated, the method embodiments described herein are not constrained to a particular order or sequence. Additionally, some of the described method embodiments or elements thereof may occur or be performed at the same point in time.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. An industrial ultrasound (US) system, comprising:
at least one US probe;
at least one mirror; and
at least one connecting unit comprising:
a probe side adjustable unit comprising a first connector connectable to a US probe and an alignment element, wherein a location of the alignment element is adjustable with respect to the US prob; and
a mirror side unit comprising a second connector connectable to a mirror and locking element located at a fixed position with respect to a reflecting surface of the mirror,
wherein the alignment element is configured to be locked by the locking element, to secure a fixed relation between a direction of a US beam emitted from the probe and the reflecting surface of the mirror.

2. The industrial UT system of claim 1, wherein the probe side unit and the mirror side unit are magnetically connected.

3. The industrial UT system of claim 1, wherein the probe side unit and the mirror side unit are mechanically connected.

4. The industrial UT system of claim 1, wherein the probe side unit and the mirror side unit are pneumatically connected.

5. The industrial UT system according to claim 1, wherein the locking element is a recess and the alignment element is a perturbance designed to be inserted into the recess, or vice versa.

6. The industrial UT system according to claim 1, wherein the locking element and the alignment element are recesses, and the connecting unit further comprises a fastener configured to secure the recesses to each other.

7. The industrial UT system according to claim 1, wherein the locking element and the alignment element are magnets.

8. A connecting unit for an industrial UT system comprising:
a probe side adjustable unit comprising a first connector connectable to at least one US probe and an alignment element, wherein a location of the alignment element is adjustable with respect to the prob; and
a mirror side unit comprising a second connector connectable to a mirror and locking element located at a fixed position with respect to a reflecting surface of the mirror,
wherein the alignment element is configured to be locked by the locking element, to secure a fixed relation between a direction of an US beam emitted from the probe and the reflecting surface of the mirror.

9. The connecting unit of claim 8, wherein the probe side unit and the mirror side unit are magnetically connected.

10. The connecting unit of claim 8, wherein the probe side unit and the mirror side unit are mechanically connected.

11. The connecting unit of claim 8, wherein the probe side unit and the mirror side unit are pneumatically connected.

12. The connecting unit according to claim 8, wherein the locking element is a recess and the alignment element is a perturbance designed to be inserted into the recess, or vice versa.

13. The connecting unit according to claim 8, wherein the locking element and the alignment element are recesses, and the connecting unit further comprises a fastener configured to secure the recesses to each other.

14. The connecting unit according to claim 8, wherein the locking element and the alignment element are magnets.

15. A method for aligning an industrial UT system, comprising:
providing a UT system comprising:
a mirror connected to a mirror side unit comprising a second connector connectable to the mirror and a locking element located at a fixed position with respect to a reflecting surface of the mirror; and
a probe connected to a probe side unit comprising a first connector connectable to the US probe and an alignment element, wherein a location of the alignment element is adjusted with respect to the probe to ensure a fixed relation between a direction of an US beam emitted from the probe and the reflecting surface of the mirror;
connecting the mirror side unit and the probe side unit; and
locking the alignment element with the locking element thereby ensure the alignment between a direction of a US beam emitted from the probe and the reflecting surface of the mirror.
